(19) United States
(12) Patent Application Publication
(10) Pub. No.: US 2004/0055021 A1
(43) Pub. Date: Mar. 18, 2004

(54) Apparatus for combining CATV channels with reduced insertion loss

(75) Inventor: Dale W. Marland, Erieville, NY (US)

Correspondence Address: BURR & BROWN, PO BOX 7068, SYRACUSE, NY, 13261-7068, US

(73) Assignee: Eagle Comtronics, Inc., Clay, NY

(21) Appl. No.: 10/629,510

(22) Filed: Jul. 29, 2003

Related U.S. Application Data
(60) Provisional application No. 60/400,000, filed on Jul. 31, 2002.

(51) Int. Cl. H04N 7/173; H04N 7/16

(52) U.S. Cl. 725/146; 725/147; 725/114; 725/116; 725/117

(57) ABSTRACT

An apparatus for combining a plurality of CATV channel signals at the head end of a CATV distribution system including a first plurality of band-pass filters each having an input for receiving a separate predetermined channel signal and an output, the output of the band-pass filters being directly connected to one another, a second plurality of band-pass filters, each having an input for receiving a separate predetermined channel signal and an output, the output of the band-pass filters being directly connected to one another, and a combiner for combining the channel signals from the first plurality with the channel signals from the second plurality.

### BACKGROUND OF THE INVENTION

The present invention relates to an apparatus for combining CATV channels at the head end of a distribution network with reduced insertion loss.

Cable service providers typically receive video feed from a plurality of sources (e.g., satellites) for distribution to customers on their distribution networks. Since many of the channels available originate from different sources, the video signal for each channel is different. The provider at the satellite end typically modulates each video signal for each channel onto a separate FM carrier, which is then transmitted to the “head end” distribution facility of a cable provider. The signals received from the satellite are demodulated to extract the video signals from the FM carriers, and then remodulated onto separate RF carriers using amplitude modulation. The video signals carried by the RF carriers are then distributed in a known manner.

At the head end facility, each video signal for each channel is passed through a separate modulator to modulate that signal onto its respective RF carrier. Since all of the CATV channels must be delivered on a single cable, it is necessary to combine the modulated channel signals together.

FIG. 1 shows a typical combination scheme used to combine 16 separate channels into one output. In the scheme shown in FIG. 1, two channels (e.g., N and N+1) are combined through a zero degree phase equal amplitude adder/combiner, which is commonly known as a 2-way splitter arranged in the reverse direction (i.e., reverse splitter). Two channels are supplied to each reverse splitter and then combined to provide a single output. Since the two channels operate at different frequencies, they can be carried on the same output bus. FIG. 1 shows that an array of reverse splitters is arranged so that the 16 channels ultimately are combined into a single output.

Although this combination scheme is used by most, if not all, cable service providers at the head end of each distribution network, there are several problems associated with this scheme. First, each reverse 2-way splitter (hereinafter combiner) adds about −3.5 dB of insertion loss to the output signal. This insertion loss accumulates through each layer of combiners, so that the overall insertion loss after combining 16 channels is about −14.0 dB. Once the loss associated with the test point (about −1 dB) is included, the overall insertion loss for 16 combined channels is about −15.0 dB.

In addition to the above, a band-pass filter is associated with each channel, and consequently, an additional −1 to −3 dB (average of −1.5 dB) insertion loss would be attributed to the band-pass filters. This would increase the overall insertion loss to about −16.5 dB for 16 channels combined into a single output in this manner. Since the combined 16 channel signal shown in FIG. 1 will be combined with numerous other combined 16 channel signals, the other combiners will contribute some insertion loss in addition to each combined 16 channel signal loss. The result is that the final recombined signal transmitted from the head end facility contains a relatively large amount of insertion loss, on the order of −27 dB when about 128 channels are combined into a single output in this way using these types of 2-way combiners.

The FCC has established minimum carrier/noise and carrier/distortion ratios that must be satisfied by the cable service provider. This is designed to ensure that each subscriber will be guaranteed a minimum level of picture quality. Since the insertion loss at the head end is so high (because of the combination scheme shown in FIG. 1), cable service providers have to employ expensive amplifiers along the distribution network to ensure that the FCC minimums are satisfied. For every 1 dB of insertion loss, the signal has to be amplified 1 dB. These amplifiers obviously increase the overall cost of not only installation of CATV networks, but also maintenance of the CATV networks, as the amplifiers need to be serviced and replaced on a regular basis.

Another problem with the scheme shown in FIG. 1 is that the modulators which are used to modulate each video signal onto its own RF carrier have changed over time. Several years ago modulator manufacturers would provide a specific modulator for each channel that had to be modulated at the head end. These modulators were also filtered to remove out of band noise from each channel signal. In recent times, however, modulator manufacturers have produced only frequency-agile modulators, which are not premodulated to any particular channel and can instead be programmed to modulate any channel. The problem with the frequency-agile modulators, however, is that they are not filtered, like the older style modulators. Consequently, the new modulators include noise across the frequency spectrum in addition to the video signal for the programmed channel. Cable service providers have thus found it necessary to employ the band-pass filters (discussed above) downstream of each frequency-agile modulator to remove the noise and pass only the video signal for the intended channel. This significantly increases cost, and contributes to the overall insertion loss upon combination, as described above.

### SUMMARY OF THE INVENTION

In accordance with a first embodiment of the present invention, an apparatus for combining a plurality of CATV channel signals at the head end of a CATV distribution system is provided, which includes a first plurality of band-pass filters each having an input for receiving a separate predetermined channel signal and an output, the output of the band-pass filters being directly connected to one another, a second plurality of band-pass filters, each having an input for receiving a separate predetermined channel signal and an output, the output of the band-pass filters being directly connected to one another, and a combiner for combining the channel signals from the first plurality with the channel signals from the second plurality.

It is preferred that each of the band-pass filters within each of the first and second pluralities operates within a separate, predetermined frequency range and the frequency ranges are spaced from one another a sufficient amount to alleviate interference between any two band-pass filters within a single plurality.

It is also preferred that one band-pass filter within the first plurality operates within the same frequency range as that of one band-pass filter within the second plurality. More preferably, each of the band-pass filters within the first plurality has a corresponding band-pass filter within the second plurality that operates within the same frequency range.

In another embodiment, one band-pass filter within the first plurality operates within a frequency range that falls between the operating frequency ranges of two frequency-adjacent band-pass filters within the second plurality. Preferably, in this embodiment, a plurality of band-pass filters within the first plurality operate within frequency ranges that are outside the operating frequency ranges of the band-pass filters within the second plurality.

It is preferred that the separate, predetermined frequency range within which each band-pass filter operates has a width of 20 MHz to 100 MHz (more preferably about 30 MHz to about 70 MHz), and the spacing between adjacent frequency ranges within a single plurality ranges from 20 MHz to 120 MHz (more preferably about 30 MHz to about 70 MHz).

As used herein, the phrase “band-pass filter” is intended to mean any type of filter that is capable of taking a signal and passing only a predetermined frequency portion of that signal. As such, band-pass filters as understood by those skilled in the art could be used in the present invention, in addition to a cascaded series of high-pass and low-pass filters which, in combination, allow only a specific frequency range portion of the signal to pass.

According to another embodiment of the present invention, an apparatus for combining a plurality of CATV channel signals at the head end of a CATV distribution system is provided. The apparatus includes at least one first module comprising a plurality of band-pass filters arranged on a substrate. Each of the band-pass filters has an input for receiving a separate, predetermined channel signal and an output. The outputs of each of the band-pass filters are directly connected to one another at a common node, such that a single output of the first module comprises a combined signal comprising each filtered signal from each of the band-pass filters of the first module. The apparatus also includes at least one second module comprising a plurality of band-pass filters arranged on a substrate. Each of the band-pass filters has an input for receiving a separate, predetermined channel signal and an output. The outputs of the band-pass filters are directly connected to one another at a common node, such that a single output of the second module comprises a combined signal comprising each filtered signal from each of the band-pass filters of the second module. Further, the apparatus includes at least one third module comprising a plurality of band-pass filters arranged on a substrate. Each of the band-pass filters has an input for receiving a separate, predetermined channel signal and an output. The outputs of the band-pass filters are directly connected to one another at a common node, such that the single output of the third module comprises a combined signal comprising each filtered signal from each of the band-pass filters of the third module. A combiner is also provided. The combiner has at least one input corresponding to the output of each of the first, second and third modules and a single output. The combiner then combines the filtered channel signals from the outputs of the first, second and the third modules into a combination signal at the single output. The apparatus can also be provided to include at least one housing containing the first modules, the second modules, the third modules and the combiner.

According to another embodiment of the present invention, an apparatus for combining a plurality of CATV channel signals at the head end of a CATV distribution system is provided. The apparatus includes a first module set comprising a plurality of first modules, each of the first modules comprising a plurality of band-pass filters arranged on a substrate. Each of the band-pass filters has an input for receiving a separate, predetermined channel signal and an output. The outputs of each of the band-pass filters are directly connected to one another at a common node, such that a single output of each of the first modules comprises a combined signal comprising a filtered signal from each of the band-pass filters for each of the first modules. The apparatus also includes a second module set comprising a plurality of second modules, each of the second modules comprising a plurality of band-pass filters arranged on a substrate. Each of the band-pass filters has an input for receiving a separate, predetermined channel signal and an output. The outputs of the band-pass filters are directly connected to one another at a common node, such that a single output of each of the second modules comprises a combined signal comprising a filtered signal from each of the band-pass filters for each of the second modules. Further, the apparatus includes a third module set comprising a plurality of third modules, each of the third modules comprising a plurality of band-pass filters arranged on a substrate. Each of the band-pass filters having an input for receiving a separate, predetermined channel signal and an output. The outputs of the band-pass filters are directly connected to one another at a common node, such that a single output of each of the third modules comprises a combined signal comprising a filtered signal from each of the band-pass filters for each of the third modules. A combiner is also provided. The combiner has at least one input corresponding to the outputs of at least a portion of the plurality of first modules, the second modules and the third modules, and the combiner has a single output. The combined, filtered channel signals from the first modules of the first module set, the second modules of the second module set and the third module of the third module set are input into the combiner and are further combined into a single combination signal at the output of the combiner with reduced insertion loss.

Preferably, the first module set includes a sufficient number of the first modules such that each CATV channel that operates within the separate, predetermined frequency range for each of the band-pass filters of the first module is individually filtered through a separate first module. Likewise, it is preferred that the second and third module sets each include a sufficient number of the second and third modules such that each CATV channel that operates within the separate, predetermined frequency range for each of the band-pass filters of the second and third modules is individually filtered through a separate one of the second and third modules, respectively, such that the combined signal from the output of the combiner includes all of the individually filtered CATV channel signals provided within the frequency ranges of each of the band-pass filters of each of the first, second and third modules.

According to yet another embodiment of the present invention, a filter module is provided, including a substrate and a plurality of band-pass filters arranged on the substrate. Each of the band-pass filters extends from an individual input for receiving a separate, predetermined channel signal and converge at a common node. The individual inputs are spaced from one another and the common node comprises a single, common output for each of the filters of the module.

Preferably, each of the band-pass filters on the module operates within a separate, predetermined frequency range. It is also preferred that the frequency ranges are spaced from one another a sufficient amount to alleviate interference between the band-pass filters on the filter module.

Preferably, each of the band-pass filters comprises a plurality of discrete electronic components that are aligned to extend from a respective one of the individual inputs toward the common node in a substantially linear manner. It is also preferred that the filters are arranged such that a first angle is defined by adjacent first and second band-pass filters, and a second angle defined by adjacent second and third band-pass filters. It is also preferred that the first angle is substantially equal to the second angle.

### BRIEF DESCRIPTION OF THE DRAWINGS

The present invention will be described in detail with reference to the following drawings, in which:

FIG. 1 shows a prior art combination scheme used to combine CATV channel signals into one output;

FIG. 2 shows a combination scheme in accordance with an embodiment of the present invention;

FIG. 3 shows the frequency ranges for signals passed through two sets of band-pass filters;

FIG. 4 shows a table of CATV channels vs. the frequencies at which those channels operate, including brackets corresponding to the different band-pass filter types for the frequency ranges shown in FIG. 3;

FIG. 5 shows frequency ranges for signals passed through 3 modules of band-pass filters according to another embodiment of the present invention;

FIG. 6 shows a truncated version of the table of CATV channels vs. their operating frequencies shown in FIG. 4, with different brackets corresponding to the band-pass filter frequency ranges shown in FIG. 5;

FIGS. 7A and 7B are schematic views of the back panel of a first module box and second module box of a combiner apparatus according to an embodiment of the present invention that have been configured to provide the band-pass filter modules shown in FIG. 5;

FIG. 8 is a schematic illustration of a three band-pass filter arrangement on one module according to an embodiment of the present invention; and

FIG. 9 is a schematic view of the three different types of filters arranged on a module and configured to correspond to the frequency ranges shown in FIG. 5.

### DETAILED DESCRIPTION OF THE INVENTION

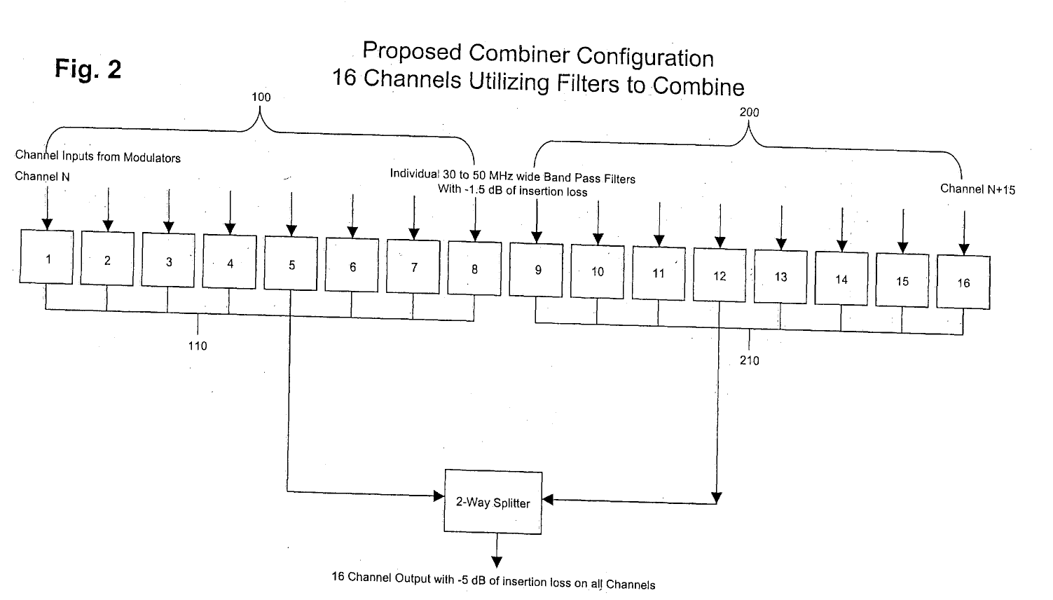

The basic concept of the present invention is to use a plurality of band-pass filters to remove the noise from each respective channel and also combine the channels together with a reduced insertion loss. FIG. 2 shows an example of a first group 100 of eight band-pass filters 1-8 used to combine eight channels together, and a second group 200 of eight band-pass filters 9-16 used to combine eight different channels together. Each channel signal will pass through its own band-pass filter, and the output of each filter will be connected to a common bus (110 for group 100 and 210 for group 200). The output signal on each common bus will include the respective eight channel signals combined together.

As mentioned above, it is not practically feasible to combine two adjacent channels (e.g., channels 2 and 3) on the same bus, because those channels operate at frequencies so close to one another that the capacitance and impedance of the two band-pass filters through which the channels pass would adversely affect one another. Accordingly, the band-pass filter for channel 2 should be arranged on one bus and a separate band-pass filter for channel 3, which separate band-pass filter operates within the same frequency bandwidth as the band-pass filter for channel 2, should be arranged in physically separate groups and combined with other signals on physically separate buses.

When deciding which channels to combine on a single bus, it is important to maintain a sufficient frequency spacing between adjacent channels. For example, a frequency spacing of 50 MHz between band-pass filters should provide sufficient isolation between adjacent filters such that the capacitance and impedance of one filter will not adversely affect the capacitance and impedance of another filter connected to the same bus. In the example shown in FIG. 2, the filters in the first group 100 (band-pass filters 1-8) and second group 200 (band-pass filters 9-16) could each be, for example, 50 MHz wide band-pass filters separated from the nearest neighboring filter by a 50 MHz frequency spacing. For example, filters 1-8 and filters 9-16 shown in FIG. 2 could have the values shown in Table 1.

TABLE 1

| | Frequency |
|---|---|
| Filters | Range |
| 1 and 9 | 50-100 MHz |
| 2 and 10 | 150-200 MHz |
| 3 and 11 | 250-300 MHz |
| 4 and 12 | 350-400 MHz |
| 5 and 13 | 450-500 MHz |
| 6 and 14 | 550-600 MHz |
| 7 and 15 | 650-700 MHz |
| 8 and 16 | 750-800 MHz |

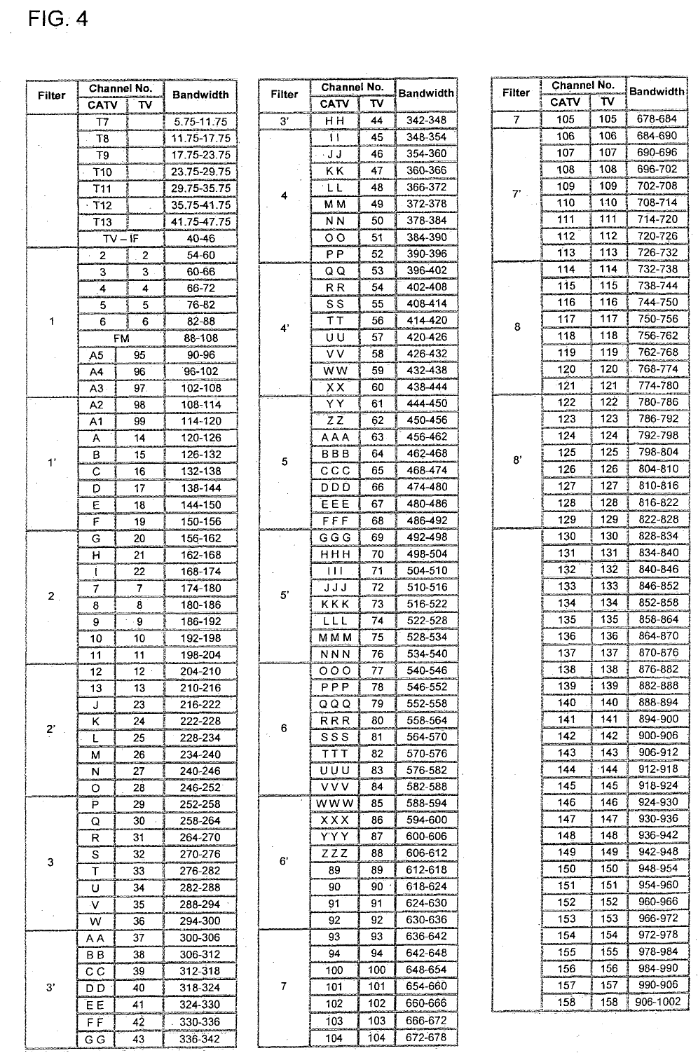

With the above arrangement, a specific channel that operates at a frequency within the frequency bandwidth of each band-pass filter would be supplied to each respective band-pass filter within first group 100. The number of channels within each frequency range is approximately 8, when the filters are selected to have the frequency ranges according to the brackets shown in FIG. 4 which is discussed in more detail below. Each band-pass filter would then pass its respective channel and remove the noise from the signal. The cleansed signal from each band-pass filter would then be combined with the other signals, so that the output from the common bus 110 includes all eight channel signals passed by filters 1-8 from group 100.

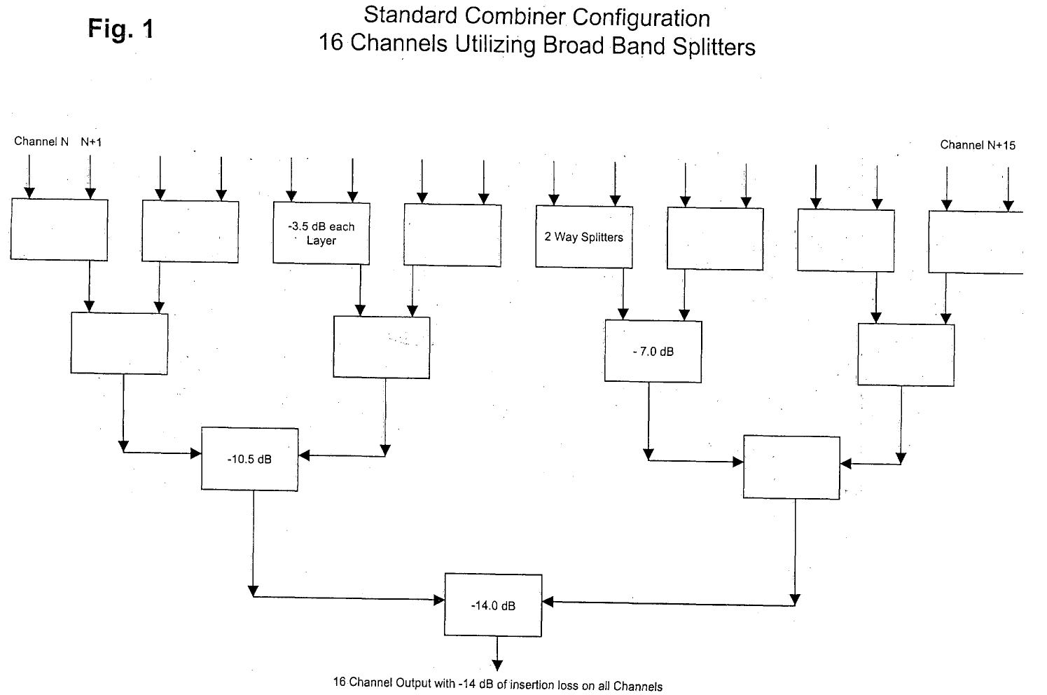

The second group 200 of eight filters 9-16 shown in FIG. 2 would likewise receive eight different channel signals, and the frequency spacing between adjacent filters could be arranged in the same manner as in the first group 100 described above. The second group 200 of filters 9-16 would then pass eight different “cleansed” signals to the common bus 210, so the output from the common bus 210 includes all eight channel signals passed by filters 9-16 from group 200. The combined 8 channel signals on the two common buses 110, 210 are then combined into a 16 channel combined signal using a standard two-way combiner, as explained above in connection with FIG. 1.

The advantage of the combination scheme shown in FIG. 2 is that several layers of 2-way combiners shown in FIG. 1 have been eliminated. Since the insertion loss contributed by each band-pass filter is only about −1.5 dB, a combined signal of 16 channels only experiences an insertion loss of about −5 dB. This decrease in insertion loss is on the order of a three-fold decrease for a combined 16 channel signal compared to the combination scheme shown in FIG. 1.

The scheme in accordance with the present invention significantly reduces the insertion loss at the head end of the cable distribution system. This will allow a huge cost savings to cable service providers. For example, it is quite common for a cable service provider to use optical communication equipment (i.e., optical fiber) to transmit CATV signals to a plurality of remote nodes that are used to supply subscribers in different geographic locations. If the scheme shown in FIG. 2 is adopted at the head end, the signal that is received at each node has considerably less insertion loss compared to the combiner scheme shown in FIG. 1. As a result, the cable service provider can achieve head end signal quality at each distribution node. This, again, reduces the need for expensive amplifier networks, and the like.

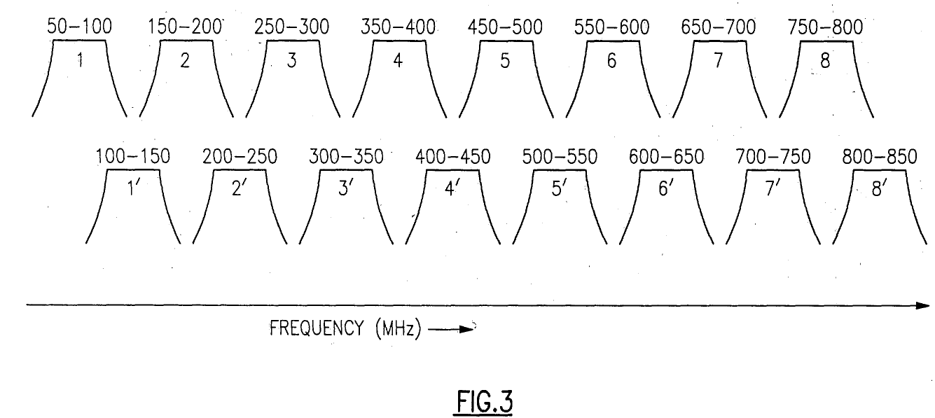

In the hypothetical example provided above with respect to the first and second groups 100, 200 of band-pass filters shown in FIG. 2, a 50 MHz frequency space is provided between each band-pass filter. Of course, additional groups of band-pass filters would be provided to cover the frequency spaces or gaps deliberately inserted between the frequency range for each filter. One example of another such group of filters 1′-8′ is shown on a frequency basis in FIG. 3 with respect to the first group 100 of filters 1-8. A similar arrangement could also be provided to cover the frequency gaps deliberately inserted between the effective frequency range for each filter of group 200 filters 9-16. In order to cover all of the channels up to 850 MHz, multiple sets of eight band-pass filters having the frequency values shown in Table 2 would be used to cover the channels that operate within the frequency spacings provided between the band-pass filters of the first two groups 100, 200 shown in Table 1.

TABLE 2

| | Frequency |
|---|---|
| Filters | Range |
| 1′ and 9′ | 100-150 MHz |
| 2′ and 10′ | 200-250 MHz |
| 3′ and 11′ | 300-350 MHz |
| 4′ and 12′ | 400-450 MHz |
| 5′ and 13′ | 500-550 MHz |
| 6′ and 14′ | 600-650 MHz |
| 7′ and 15′ | 700-750 MHz |
| 8′ and 16′ | 800-850 MHz |

A plurality of buses would be arranged in a repeating fashion to cover all of the desired channels within the above frequency ranges, and the signals would be combined in the same manner described above with respect to FIG. 2.

FIG. 4 shows a table of CATV channels vs. the standard frequency ranges at which those channels operate. The frequency channels therein have been bracketed by reference to filters 1-8 and 1′-8′. Each of the 8 channel signals provided with the selected frequency range included within bracket No. 1, for example, would be passed through a separate No. 1 filter arranged in a separate group. The channels in bracket No. 2 would each be passed through a separate No. 2 filter in separate groups, and so on. Likewise, each of the channels in bracket No. 1′ would be passed through a separate No. 1′ filter in a separate group. This would be the same for filters 9-16 and 9′-16′, as well. Similar groupings of separate 8 filter groups and buses would be provided until all of the channels in the frequency spectrum up to 850 MHz have been matched up with a respective band-pass filter. The resultant combined signal would include all channels, but at reduced insertion loss compared to the scheme in FIG. 1.

FIG. 4 shows that bracket No. 1 includes channels 2-6 and channels A-5, A-4 and A-3, which operate at frequencies ranging from 54.0 MHz to 108.0 MHz. Accordingly, the width of the No. 1 filter would actually have to be wider than exactly 50 MHz to allow passage of the signal for channel A-3 (i.e., a 54-108 MHz bandwidth). Even if the width of the No. 1 filter is widened to include 108 MHz, that frequency band is still sufficiently spaced from the lowest frequency of bracket No. 2 (i.e., channel G at 156.0 MHz) so that sufficient isolation will exist between the No. 1 filter in the group that carries channels from bracket No. 1 and the No. 2 filter on the same bus that carries channels from bracket No. 2. A similar situation appears in bracket No. 1′, since channel F operates at an upper frequency of 156.0 MHz. Accordingly, the width of the No. 1′ filter would also have to be wide enough to allow passage of the signal for channel F. In fact, this same scenario occurs for several of the channel brackets shown in FIG. 4. Suffice it to say that one skilled in the art could easily select appropriate frequency ranges for the filters while roughly maintaining a 50 MHz bandwidth for each filter to achieve the objectives of the present invention, without having to strictly follow the hypothetical values in Tables 1 and 2 above, which were merely set at exactly 50 MHz intervals for ease of example and explanation.

While the embodiment described above employs groups of band-pass filters having a 50 MHz operating range as an example, band-pass filters having different bandwidths could also be employed, ranging from 20 MHz to 100 MHz. The smaller bandwidth band-pass filters obviously handle fewer channels since the frequency range is smaller, whereas the larger bandwidth band-pass filters can handle more channels within the broader frequency range. However, as the width of the frequency range for the band-pass filters decreases, the insertion loss attributable to the band-pass filters typically increases, as well. As the width increases the filters cleansing effect decreases. Accordingly, a preferred width for each filter is in a range of 30 to 50 MHz.

The spacing between adjacent filters preferably follows the bandwidth selected for each filter in the above embodiment. For example, if each band-pass filter has a bandwidth of 50 MHz, then the spacing between adjacent filters is preferably 50 MHz, to provide commonality among components and reduce manufacturing costs. Of course, it is not necessary that the frequency spacing between filters match the operating bandwidth of each filter. The operating bandwidth simply dictates the number of channels that can be passed through each filter, whereas the frequency spacing between filters prevents interference from filter-to-filter in any given group combined by a common bus. If the frequency spacing between filters is too low (e.g., less than 20 MHz), then interference between adjacent filters is more likely to occur. This is the same reason that filters for both channels 2 and 3 within the same frequency range are not arranged in the same group, as explained above.

Additionally, if the frequency spacing between adjacent filters is not wide enough, it may not be possible to tune one filter to the desired frequency without de-tuning an adjacent filter. Accordingly, the spacing between filters should be at least 20 MHz to avoid this problem. If the frequency spacing between filters becomes too high (e.g., much greater than 100 MHz), more groups of filters would be needed in order to cover all channels, which in turn would increase the number of group combiners and the overall insertion loss of the apparatus (since each individual group and combiner contributes to the overall insertion loss).

The individual band-pass filters employed in the present invention can be readily manufactured by any skilled CATV engineer. While the embodiment described above uses eight filters per group, it is of course possible to group less than eight or more than eight filters in a single group, depending upon application objectives such as the degree coverage over the frequency spectrum, packaging considerations, insertion losses attributed to multiple combinations, etc.

In some situations, however, it may be difficult to manufacture and practically implement a combiner apparatus where the frequency spacing between adjacent filters of a single group is 50 MHz or less. While it is certainly possible to use sharper, more precise filters in order to better filter the desired frequencies and prevent noise overlap or interference between adjacent frequency bands and such, the higher costs associated with high quality, high precision filters detracts from the practicality of implementing these types of filters and counters the cost benefits provided by the combination schemes according to the present invention.

Moreover, while the above example embodiment covers channels theoretically ranging from 50 MHz to around 850 MHz using filters separated by approximately 50 MHz increments, the frequency spectrum extends beyond 850 MHz up to about 1000 MHz, for channel 158 at 906-1002 MHz for example, as shown in FIG. 4. In applications where combining all of the possible channels over the entire frequency spectrum is desired, it would be apparent to one skilled in the art that the number of groups could be adjusted and that the frequency spacing between filters and/or the filter bandwidth could be appropriately changes (i.e., widened or narrowed) to accommodate the additional frequency ranges and channels.

It should be noted, however, that in practice, the need to combine signals does not often occur at frequencies extending above the analog signal spectrum, which terminates around 550 MHz. That is, there are other considerations and implications associated with the digital communications signals transmitted at frequencies above 550 MHz. The following example describes a combiner apparatus according to another embodiment of the present invention that addresses a smaller range of overall frequencies, that is, the frequencies transmitted between about 50 and about 552 MHz.

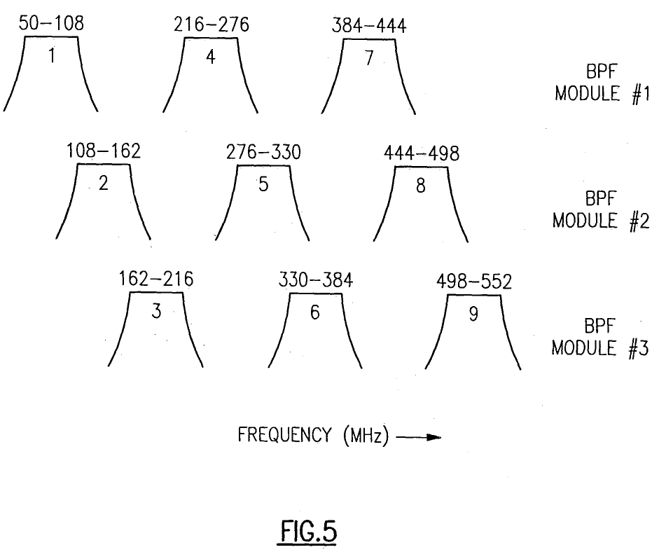

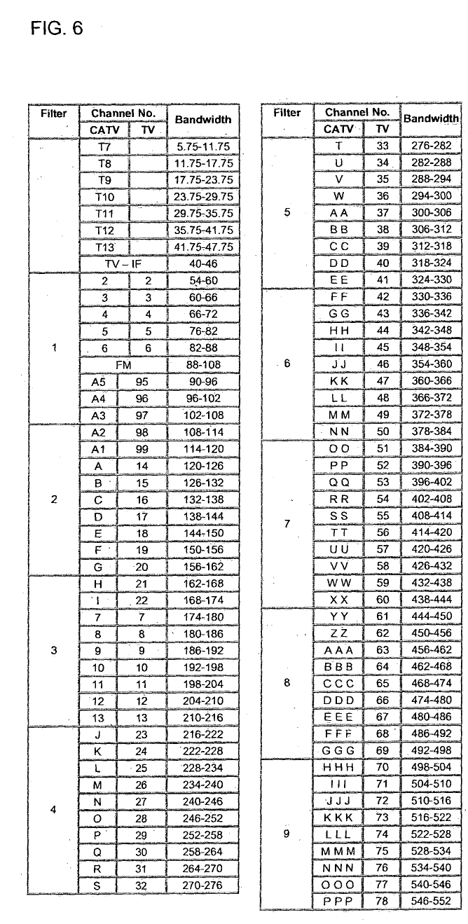

FIG. 5 shows, on a frequency basis, the frequency bandwidths for nine different types of band-pass filters, where three of the nine filters are provided in each of three modules for a combiner configuration according to another embodiment of the present invention. FIG. 6 is a truncated version of the CATV Channel vs. Standard Frequency Chart of FIG. 4, showing the different bracketed frequency ranges corresponding to each of filters 1-9 according to this embodiment of the present invention. When read in connection with FIG. 5, the numerical distance (i.e., frequency spacing) between adjacent filters provided on a single module is better understood. The frequency bandwidths (ΔF) of each type of filter are also shown in Table 3 below, along with the number of channels associated with each bracketed filter type and its corresponding frequency range.

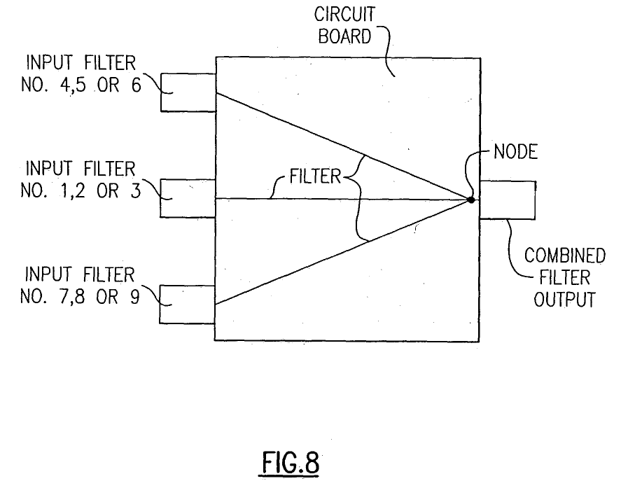

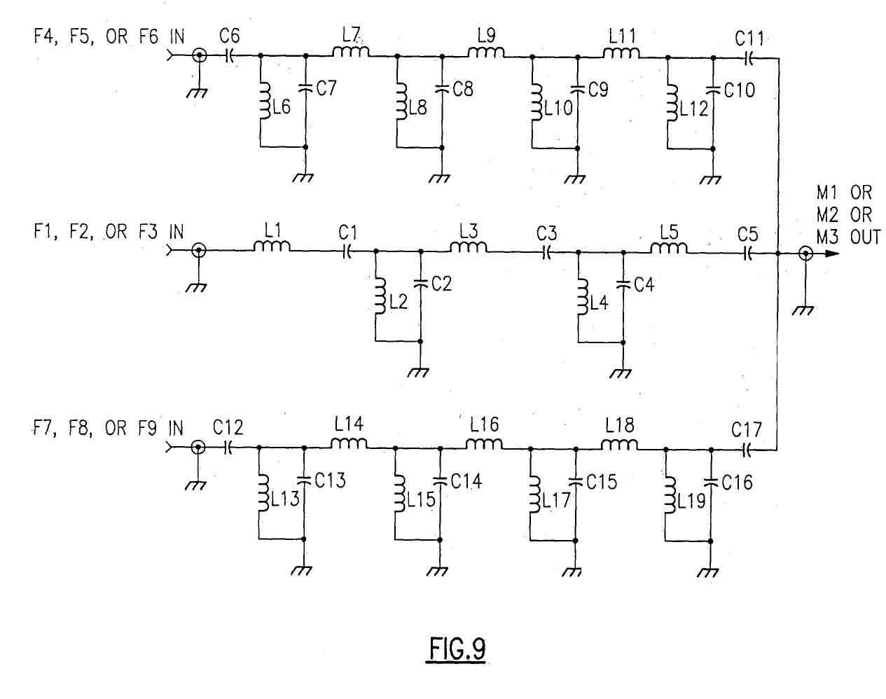

FIG. 5 shows that Module No. 1 includes band-pass Filter Nos. 1, 4 and 7, Module No. 2 includes band-pass Filter Nos. 2, 5 and 8, and Module No. 3 includes band-pass Filter Nos. 3, 6 and 9. Each of the different band-pass Filter Nos. 1-9 according to this embodiment pass frequencies within a different frequency range. As shown in Table 3 below, the frequency ranges of the 3 different filters of each module are spaced approximately 100 MHz apart. The filter structure and arrangement of the different filter types on each of the three different modules according to this embodiment of the present invention are described below in connection with FIGS. 8 and 9.

TABLE 3

| Module | Filter No. | Frequency Range | (ΔF) |
|---|---|---|---|
| 1 | 1 | 50-108 | 58 |
| | 4 | 216-276 | 60 |
| | 7 | 384-444 | 60 |
| 2 | 2 | 108-162 | 54 |
| | 5 | 276-330 | 54 |
| | 8 | 444-498 | 54 |
| 3 | 3 | 162-216 | 54 |
| | 6 | 330-384 | 54 |
| | 9 | 498-552 | 54 |

As shown in Table 3, the three different band-pass filters (Nos. 1, 4, 7) included in Module No. 1 are configured to pass a slightly wider bandwidth (ΔF=58 or 60 MHz) six other filters included in Modules Nos. 2 and 3, which each have a bandwidth of ΔF=54 MHz. The reason for the difference in the effective bandwidth (ΔF) of the filters in Module No. 1 and those in Modules Nos. 2 and 3 is explained below.

The No. 1 band-pass filter of this embodiment is configured to pass signals transmitted within the 50-108 MHz range (a total bandwidth ΔF of 58 MHz). Referring to FIG. 6, the industry designation scheme implemented many years ago provided a 4.0 MHz frequency gap between the channel 4 frequency bandwidth and the channel 5 frequency bandwidth that is not assigned to any particular channel (since most channels operate in a 6 MHz frequency band). Additionally, as shown in FIG. 6, the 2 MHz gap provided between the channel 6 frequency band and the channel A-5 frequency band (90.0-96.0) is designated for FM signals, which are not typically included as a part of the standard CATV transmission signals after modulation. While the frequencies associated with these gaps total 6 MHz, the gaps are spaced apart from each other, and as such, cannot be effectively combined to carry a common 6 MHz band channel signal at any particular frequency. Thus, within the first frequency bracket in FIG. 6, the total number of channels transmitted is only 8, and a wider range than a 50 MHz frequency span is required in order to cover these 8 channels. The gaps, however, provide a signal “space” into which pilot signals can be inserted to provide administrative inputs and to facilitate communications between the headend and a residential set-top box, for example. Thus, in addition to the 8 channels included within this first frequency range, two optional pilot signal ports can be provided as well, for a total of 10 “channel” inputs within the first frequency range.

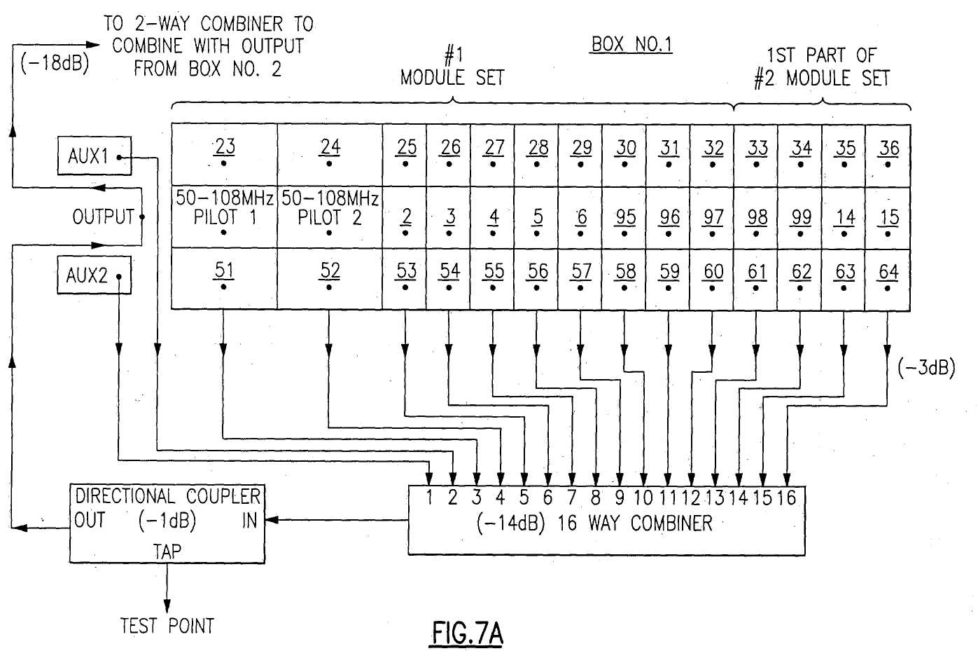

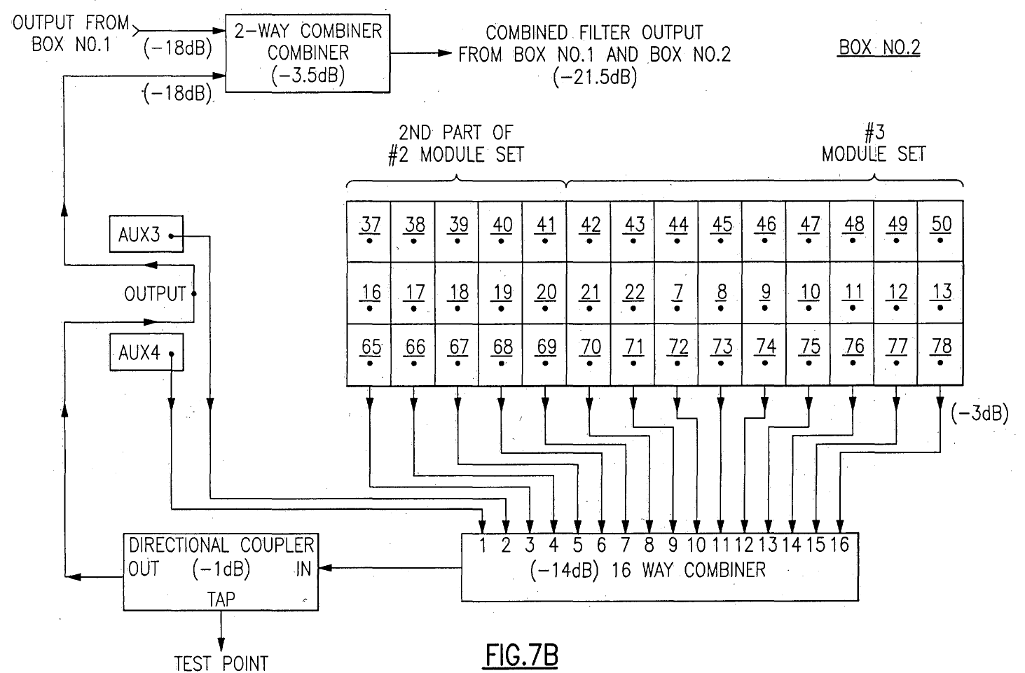

Since the frequency ranges for the band-pass filters and number of channel inputs within that range should optimally be consistent among the three different filter types within a single module, and since the No. 1 filter effectively covers 10 inputs, the frequency ranges for the No. 4 filter and the No. 7 filter of Module No. 1 are each set to pass frequencies in a 60 MHz span. The 60 MHz bandwidths of the fourth and seventh frequency ranges shown in FIG. 6 each accommodate 10 channel inputs. Thus, a balance is achieved among the three filters provided in the No. 1 module with respect to both the bandwidth of the Nos. 1, 4 and 7 filters, as well as the effective number of channels associated with each bandwidth. In order to provide, and then combine, each of the individual channels for the channel inputs in the three ranges covered by band-pass filter Nos. 1, 4 and 7 on Module No. 1, ten of these first modules are provided so that each channel is filtered separately before being combined as described below with reference to FIGS. 7A and 7B.

FIGS. 5 and 6 also show that each of the three filters in the second filter module (Nos. 2, 5 and 8 filters) and each of the three filters in the third filter module (Nos. 3, 6 and 9 filters) have a 54 MHz bandwidth which includes about 9 channel inputs each. The filters are arranged on the second and third modules in much the same manner as the filters of the first module, and this arrangement is described in more detail below with reference to FIGS. 8 and 9. In order to provide, and then combine, each of the individual channels in the three ranges covered by Filter Nos. 2, 5 and 8 on Module No. 2, nine of these second modules are provided. Likewise, in order to provide, and then combine, each of the individual channels in the three ranges covered by Filter Nos. 3, 6 and 9 on Module No. 3, nine of these third modules are also provided so that each channel is filtered separately before combined as described below with reference to FIGS. 7A and 7B. All said, a total of 28 separate modules are provided to cover all of the 82 channels in the bracketed ranges between 50 MHz and 552 MHz.

The total frequency range covered by the three modules according to this example embodiment is about 50-552 MHz, which includes the entire analog frequency span and excludes the digital and broadband signals carried at frequencies above 552. The total number of channel inputs to be combined is 88, which is broken down in the following manner. The first frequency range (50-108 MHz) provides 8 channel inputs and 2 pilot inputs; the remaining frequency range from 108-552 MHz covers 74 channel inputs, and the physical configuration of the combiner apparatus described with reference to FIGS. 7A and 7B provides a total of 4 external auxiliary inputs for a total of 88 input ports. Thus, the combiner apparatus according to this example embodiment of the present invention can combine 88 inputs into a single output with a reduced insertion loss as compared to conventional combiner systems, such as the system described above in connection with FIG. 1.

Combining 88 discrete inputs into a single output while incurring a minimum amount of insertion loss is achieved, for example, by employing the combiner apparatus configuration shown in FIGS. 7A and 7B. Due to packaging constraints and practical size limitations, a dual-box apparatus is used in this embodiment, wherein the first box (Box No. 1) is shown in FIG. 7A and the second box (Box No. 2) is shown in FIG. 7B. It should be noted, however, that while design considerations and practical applications typically dictate the physical configuration of any apparatus used in any particular application, larger boxes, a single box, or more boxes could instead be used, along with a number of other physically different combinations, without departing from the spirit of the present invention. That is, the scope of the present invention is not in any way limited to the examples described herein.

Box No. 1 shown in FIG. 7A combines 40 channel inputs, 2 pilot inputs, and 2 external auxiliary inputs into a single output using a standard 16-way combiner. Box No. 2 shown in FIG. 7B combines 42 channel inputs and 2 external auxiliary inputs into a single output using another standard 16-way combiner. The single output from Box No. 2 is then combined with the single output from Box No. 1 via a standard 2-way combiner to ultimately combine 88 individually filtered inputs into a single output line.

Referring to FIG. 7A, ten No. 1 Modules (including band-pass Filter Nos. 1, 4 and 7 on No. 1 Module), is arranged in Box No. 1. A minimum distance of about 1.25 inches is provided between adjacent modules within Box No. 1 in order to prevent magnetic interference and cross talk phenomena, which disturbs and inhibits the proper performance of the band-pass filters on the modules, and thus, the entire combiner apparatus. Since in this example configuration, each box is sized to accommodate up to 14 modules, in addition to the ten No. 1 Modules, four No. 2 filter modules (including band-pass Filter Nos. 2, 5 and 8 on each No. 2 Module), is also arranged in Box No. 1. This set of No. 2 Modules comprises a portion of the total set of nine No. 2 Modules for the combiner. That is, since a total of nine No. 2 Modules are required to provide all of the channels included in the frequency ranges covered by the filters on each No. 2 Module, the remaining 5 modules of the set of No. 2 Modules are provided in Box No. 2 (see FIG. 7B), along with the entire set of nine No. 3 Modules, for a total of 14 modules in Box No. 2.

Each module effectively combines 3 filtered channel inputs into a single output. This is described in more detail below in connection with FIGS. 8 and 9. The 14 outputs, one for each module in Box No. 1, are then input into a first 16-way combiner, which can also receive input from the 2 auxiliary external inputs shown in FIG. 7A, so that each input port of the first 16-way combiner is associated with an input signal. The output from the 16-way combiner from Box No. 1 is input into one input port of a 2-way combiner.

Similar to the configuration of Box No. 1, 14 module outputs, one for each module in Box No. 2, are input into a second 16-way combiner, which can also receive input from the 2 external auxiliary inputs shown in FIG. 7B, so that each input port of the second 16-way combiner is associated with an input signal. The output from the 16-way combiner from Box No. 2 is input into the other input port of the 2-way combiner, such that the single combined signal from the 44 combined inputs from Box No. 1 and the combined signals from the 44 inputs with Box No. 2 are then combined into a single output.

The insertion losses incurred by combining the inputs associated with Box Nos. 1 and 2 are calculated as follows. The filter modules contribute about a −3 dB of insertion loss. The 16-way combiners contribute about a −14 dB of loss, and the directional coupler (test point) adds another −1 dB of loss for a total of about a −18 dB insertion loss for each combined 44-channel output before the combined 44 channel signal from Box No. 1 is combined with the combined 44 channel signal from Box No. 2. The 2-way combiner adds another −3.5 dB of loss, such that the combined 88 channel output experiences about a −21.5 dB insertion loss overall. When comparing the insertion losses attributed to the combiner apparatus according to this embodiment of the present invention to the overall insertion loss attributed to the conventional combiner configuration shown, for example, in FIG. 1, it should be noted that the total number of channel inputs combined in this embodiment (88) is more than two times the number combined in the conventional configuration (32) at a comparable loss value.

That is, the overall insertion loss of about −20 dB for the combined channel conventional configuration of FIG. 1 is calculated as follows: −1.5 dB for the band-pass filters (not shown in FIG. 1); −14 dB after the 16 channels are combined; −1 dB for a test point (not shown in FIG. 1) and another −3.5 dB for the 2-way combiner required to combine the combined 16 channel signal with another combined 16 channel signal for a total of 32 combined inputs in a single output. Thus, the total insertion loss for a combined 32-channel signal is about −20 dB. In order to combine even more channels, an additional −3.5 dB loss is associated with each additional 2-way combiner needed to add another combined 32 channel signal. In that manner, the total loss for a combined 64 channel signal would be about −23.5 dB, a loss of about −27 dB could be expected for a combined 128 channel signal, and so forth until all the channels in the desired frequency spectrum are effectively combined.

Referring to FIG. 7A, however, it can be seen that the total insertion loss for Box No. 1 of the combiner apparatus of the present invention is −18 dB loss for the combined 44 input signal, and when that is combined with the combined 44 input signal (which also has −18 dB loss) from Box No. 2, adding the −3.5 dB loss contributed by for 2-way combiner that joins the combined signals from Box No. 1 and Box No. 2, the total insertion loss is about −21.5 dB insertion loss for an 88 “channel” combined signal on a single output.

This loss also represents the total loss involved in combining all of the desired channels in the 50 MHz-550 MHz range (below digital transmission). Even if one skilled in the art were to apply the conventional method and combine only the channels in the 50-550 MHz range instead of the 132 channels up to 852 MHz, the total insertion loss would still be more than the total loss of −21.5 dB attributed to the configuration shown in FIGS. 7A and 7B. This is important, especially when it is considered that the half-power point is about 3.0 dB, such that even a 3 dB decrease in insertion loss essentially doubles the power output and significantly reduces the amplification required to comply with FCC regulations.

FIG. 8 is a schematic view of a module according to the above embodiment of the present invention. That is, as mentioned above, each module M1-M3 includes three different band-pass filters: M1=Filter Nos. 1, 4 and 7; M2=Filter Nos. 2, 5 and 8: and M3=Filter Nos. 3, 6 and 9, with each filter type having an input. The three filter structures on each module are arranged to extend in a substantially linear fashion from a respective input to converge at a common node as a single output. The effective length of each filter on the module is controlled such that the minimum possible distance is provided between the end of the filter and the connection point of the common node. In that manner, the three filters converge at the common node such that the first component (first lead) of each filter is an intimate part of the node's footprint. That is, the first leads of each filter are all provided at the same point so that the node will function as a common output for the three filters.

FIG. 9 is a schematic diagram showing an example of the general configuration of the different filter components comprising the three different filter types for modules M1-M3 described above. Table 4 shows the respective values for the filter components of the three filters on the module shown in FIG. 9. One skilled in the art would readily understand that the values of these filter components could be changed according to the desired frequency bandwidth of each filter, and that the number of modules and the number of filters per module could also be varied.

TABLE 4

| | M1 With F1, F4, | M2 With F2, F5, | M3 With F3, F6 |
|---|---|---|---|
| | and F7 | and F8 | and F9 |
| C1 | 27 | 8.2 | 3.9 |
| C2 | 51 | 39 | 30 |
| C3 | 15 | 4.2 | 1.5 |
| C4 | 51 | 39 | 30 |
| C5 | 27 | 8.2 | 3.9 |
| C6 | 5.6 | 4.2 | 3.6 |
| C7 | 5.6 | 5.2 | 5.2 |
| C8 | 9.1 | 8.2 | 7.5 |
| C9 | 9.1 | 8.2 | 7.5 |
| C10 | 5.6 | 5.2 | 5.2 |
| C11 | 5.6 | 4.2 | 3.6 |
| C12 | 2.7 | 2 | 1.8 |
| C13 | 4.7 | 3.9 | 3.6 |
| C14 | 6.2 | 4.7 | 3.9 |
| C15 | 6.2 | 4.7 | 3.9 |
| C16 | 4.7 | 3.9 | 3.6 |
| | 2.7 | 2.2 | 2.7 |
| L1 | 180 | 180 | 180 |
| L2 | 5.5/150/26 | 3.5/100/26 | 2.5/100/26 |
| L3 | 330 | 330 | 330 |
| L4 | 5.5/150/26 | 3.5/100/26 | 2.5/100/26 |
| L5 | 180 | 180 | 180 |
| L6 | 3.5/150/24 | 3.5/150/22 | 2.5/150/22 |
| L7 | 180 | 150 | 130 |
| L8 | 4.5/150/24 | 3.5/150/22 | 2.5/150/22 |
| L9 | 200 | 180 | 150 |
| L10 | 4.5/150/24 | 3.5/150/22 | 2.5/150/22 |
| L11 | 180 | 150 | 130 |
| L12 | 3.5/150/24 | 3.5/150/22 | 2.5/150/22 |
| L13 | 2.5/100/26 | 2.5/100/26 | 2.5/100/22 |
| L14 | 130 | 130 | 120 |
| L15 | 2.5/100/26 | 2.5/100/26 | 2.5/115/24 |
| L16 | 160 | 160 | 160 |
| L17 | 2.5/100/26 | 2.5/100/26 | 2.5/115/24 |
| L18 | 130 | 130 | 120 |
| L19 | 2.5/100/26 | 2.5/150/22 | 2.5/100/22 |

F1 50-108 MHz
F2 108-162 MHz
F3 162-216 MHz
F4 216-276 MHz
F5 276-330 MHz
F6 330-384 MHz
F7 384-444 MHz
F8 444-498 MHz
F9 498-552 MHz−

As shown in Table 4, the capacitance values of capacitors C1-C16 are the same for each of the filters on a respective module M1-M3, while these capacitor values differ from module to module. Inductors L1, L3, L5, L7, L9, L11, L14, L16, and L18 have the same value for each of the filters on a respective module, and these values also differ from module to module. The values of inductors L2, L4, L6, L8, L10, L12-L13, L15, L17 and L19, however, are different for each respective filter on a given module, such that the individual filters can each be tuned to the desired and proper frequency bandwidths, which are also shown at the bottom of Table 4.

Thus, the above examples of embodiments of the present invention show that band-pass filters can be used to individually filter signals from a plurality of inputs and then combine the filtered signals into a single output without incurring the insertion losses associated with known combiner schemes.

While the present invention has been particularly shown and described with reference to the drawings and tables included herein, it will be understood by one skilled in the art that various changes in detail may be effected therein without departing from the spirit and scope of the invention as defined by the claims.

What is claimed:

1. An apparatus for combining a plurality of CATV channel signals at the head end of a CATV distribution system, comprising:
a first plurality of band-pass filters each having an input for receiving a separate, predetermined channel signal and an output, the output of the band-pass filters being directly connected to one another;
a second plurality of band-pass filters, each having an input for receiving a separate, predetermined channel signal and an output, the output of the band-pass filters being directly connected to one another; and
a combiner for combining the channel signals from said first plurality of band-pass filters with the channel signals from said second plurality of band-pass filters.

2. The apparatus of claim 1, wherein each of the band-pass filters within each of said first and second pluralities operates within a separate, predetermined frequency range and the frequency ranges are spaced from one another a sufficient amount to alleviate interference between any two band-pass filters within a single plurality.

3. The apparatus of claim 2, wherein one band-pass filter within said first plurality operates within the same frequency range as that of one band-pass filter within said second plurality.

4. The apparatus of claim 2, wherein each of said band-pass filters within said first plurality has a corresponding band-pass filter within said second plurality that operates within the same frequency range.

5. The apparatus of claim 2, wherein one band-pass filter within said first plurality operates within a frequency range that falls between the operating frequency ranges of two frequency-adjacent band-pass filters within said second plurality.

6. The apparatus of claim 2, wherein a plurality of band-pass filters within said first plurality operate within frequency ranges that are outside the operating frequency ranges of the band-pass filters within said second plurality.

7. The apparatus of claim 2, wherein said separate, predetermined frequency range has a bandwidth in a range of 20 MHz to 100 MHz, and the spacing between adjacent frequency ranges within a single plurality ranges from 20 MHz to 100 MHz.

8. The apparatus of claim 7, wherein said bandwidth is in a range of 30 MHz to 70 MHz and said spacing is in a range of 30 MHz to 70 MHz.

9. An apparatus for combining a plurality of CATV channel signals at the head end of a CATV distribution system, comprising:
at least one first module comprising a plurality of band-pass filters arranged on a substrate, each of said band-pass filters having an input for receiving a separate, predetermined channel signal and an output, said output of each of said band-pass filters being directly connected to one another at a common node, such that a single output of said first module comprises a combined signal comprising each filtered signal from each of said band-pass filters of said first module;
at least one second module comprising a plurality of band-pass filters arranged on a substrate, each of said band-pass filters having an input for receiving a separate, predetermined channel signal and an output, said output of said band-pass filters being directly connected to one another at a common node, such that a single output of said second module comprises a combined signal comprising each filtered signal from each of said band-pass filters of said second module;
at least one third module comprising a plurality of band-pass filters arranged on a substrate, each of said band-pass filters having an input for receiving a separate, predetermined channel signal and an output, said output of said band-pass filters being directly connected to one another at a common node, such that a single output of said third module comprises a combined signal comprising each filtered signal from each of said band-pass filters of said third module; and
a combiner having at least one input corresponding to said output of each of said first, second and third modules and a single output, wherein said combiner combines the combined, filtered channel signals from said outputs of said first, second and said third modules into a combination signal at said single output.

10. The apparatus of claim 9, wherein said band-pass filters of each of said first, second and third modules operates within a separate, predetermined frequency range and said frequency ranges of said band-pass filters on any one of said first, second and third modules are spaced from one another a sufficient amount to alleviate interference between respective band-pass filters on said first module, said second module and said third module.

11. The apparatus of claim 10, wherein at least one band-pass filter of said first module operates within a frequency range that falls between the operating frequency ranges of two frequency-adjacent band-pass filters of said second module and said third module.

12. The apparatus of claim 10, wherein at least one band-pass filter of said second module operates within a frequency range that falls between the operating frequency ranges of two frequency-adjacent band-pass filters of said first module and said third module.

13. The apparatus of claim 10, wherein at least one band-pass filter of said third module operates within a frequency range that falls between the operating frequency ranges of two frequency-adjacent band-pass filters of said first module and said second module.

14. The apparatus of claim 10, wherein said separate, predetermined frequency range has a bandwidth in a range of 20 MHz to 100 MHz, and the spacing between adjacent frequency ranges for said band-pass filters on each of said first module, said second module and said third module ranges from 20 MHz to 120 MHz.

15. The apparatus of claim 14, wherein said bandwidth is in a range of 30 MHz to 70 MHz and said spacing is in a range of 50 MHz to 120 MHz.

16. The apparatus of claim 10, comprising a sufficient number of said first modules such that each CATV channel that operates within said separate, predetermined frequency range for each of said band-pass filters of said first module is individually filtered through a separate first module;
a sufficient number of said second modules such that each CATV channel that operates within said separate, predetermined frequency range for each of said band-pass filters of said second module is individually filtered through a separate second module; and
a sufficient number of said third modules such that each CATV channel that operates within said separate, predetermined frequency range for each of said band-pass filters of said third module is individually filtered through a separate third module;
such that the combined signal from said output of said combiner includes all of the individually filtered CATV channel signals provided within the frequency ranges of each of said band-pass filters of each of said first, second and third modules.

17. The apparatus of claim 16, further comprising at least one housing, said housing containing said first modules, said second modules, said third modules and said combiner.

18. An apparatus for combining a plurality of CATV channel signals at the head end of a CATV distribution system, comprising:
a first module set comprising a plurality of first modules, each of said first modules comprising a plurality of band-pass filters arranged on a substrate, each of said band-pass filters having an input for receiving a separate, predetermined channel signal and an output, said output of each of said band-pass filters being directly connected to one another at a common node, such that a single output of each of said first modules comprises a combined signal comprising a filtered signal from each of said band-pass filters for each of said first modules;
a second module set comprising a plurality of second modules, each of said second modules comprising a plurality of band-pass filters arranged on a substrate, each of said band-pass filters having an input for receiving a separate, predetermined channel signal and an output, said output of said band-pass filters being directly connected to one another at a common node, such that a single output of each of said second modules comprises a combined signal comprising a filtered signal from each of said band-pass filters for each of said second modules;
a third module set comprising a plurality of third modules, each of said third modules comprising a plurality of band-pass filters arranged on a substrate, each of said band-pass filters having an input for receiving a separate, predetermined channel signal and an output, said output of said band-pass filters being directly connected to one another at a common node, such that a single output of each of said third modules comprises a combined signal comprising a filtered signal from each of said band-pass filters for each of said third modules; and
at least one combiner having at least one input corresponding to said outputs of at least a portion of said plurality of first modules, said second modules and said third modules, said combiner having a single output;
wherein the combined, filtered channel signals from said first modules of said first module set, said second modules of said second module set and said third module of said third module set are input into said combiner and are further combined into a single combination signal at said output of said combiner with reduced insertion loss.

19. The apparatus of claim 18, wherein said band-pass filters of each of said first, second and third modules operates within a separate, predetermined frequency range and said frequency ranges of said band-pass filters on any one of said first, second and third modules are spaced from one another a sufficient amount to alleviate interference between respective band-pass filters on said first module, said second module and said third module.

20. The apparatus of claim 19, wherein at least one band-pass filter of said first module operates within a frequency range that falls between the operating frequency ranges of two frequency-adjacent band-pass filters of said second module and said third module.

21. The apparatus of claim 19, wherein at least one band-pass filter of said second module operates within a frequency range that falls between the operating frequency ranges of two frequency-adjacent band-pass filters of said first module and said third module.

22. The apparatus of claim 19, wherein at least one band-pass filter of said third module operates within a frequency range that falls between the operating frequency ranges of two frequency-adjacent band-pass filters of said first module and said second module.

23. The apparatus of claim 19, wherein said separate, predetermined frequency range has a bandwidth in a range of 20 MHz to 100 MHz, and the spacing between adjacent frequency ranges for said band-pass filters on each of said first module, said second module and said third module ranges from 20 MHz to 120 MHz.

24. The apparatus of claim 23, wherein said bandwidth is in a range of 30 MHz to 70 MHz and said spacing is in a range of 50 MHz to 120 MHz.

25. The apparatus of claim 19, comprising a sufficient number of said first modules such that each CATV channel that operates within said separate, predetermined frequency range for each of said band-pass filters of said first module is individually filtered through a separate first module;
a sufficient number of said second modules such that each CATV channel that operates within said separate, predetermined frequency range for each of said band-pass filters of said second module is individually filtered through a separate second module; and
a sufficient number of said third modules such that each CATV channel that operates within said separate, predetermined frequency range for each of said band-pass filters of said third module is individually filtered through a separate third module;
such that the combined signal from said output of said combiner includes all of the individually filtered CATV channel signals provided within the frequency ranges of each of said band-pass filters of each of said first, second and third modules.

26. The apparatus of claim 25, further comprising at least one housing, said housing containing said first modules, said second modules, said third modules and said combiner.

27. A filter module, comprising:
a substrate; and
a plurality of band-pass filters arranged on said substrate, each of said band-pass filters extending from an individual input for receiving a separate, predetermined channel signal and converging at a common node, said individual inputs being spaced from one another and said common node comprising a single, common output for each of said filters of said module;
wherein each of said band-pass filters operates within a separate, predetermined frequency range and said frequency ranges are spaced from one another a sufficient amount to alleviate interference between said band-pass filters on said filter module.

28. The filter module of claim 27, wherein each of said band-pass filters comprise a plurality of discrete electronic components that are aligned to extend from a respective one of said individual inputs toward said common node in a substantially linear manner.

29. The filter module of claim 28, wherein a first angle is defined by adjacent first and second band-pass filters, and a second angle defined by adjacent second and third band-pass filters.

30. The filter module of claim 29, wherein said first angle is substantially equal to said second angle.

31. The filter module of claim 27, wherein each of said band-pass filters operates within a separate, predetermined frequency range and the frequency ranges are spaced from one another a sufficient amount to alleviate interference between any two band-pass filters on said module.

32. The filter module of claim 31, wherein said separate, predetermined frequency range has a bandwidth in a range of 20 MHz to 100 MHz, and the spacing between adjacent frequency ranges for said band-pass filters on said module ranges from 20 MHz to 120 MHz.
